(19) United States
(12) Patent Application Publication
(10) Pub. No.: US 2004/0079798 A1
(43) Pub. Date: Apr. 29, 2004

(54) Video rental/purchase system and methods

(76) Inventors: Chad Messenger, Pound Ridge, NY (US); Stephen Intrieri, Mount Laurel, NJ (US)

Correspondence Address: Mark P. Stone, 25 Third Street, 4th Floor, Stamford, CT, 06905, US

(21) Appl. No.: 10/279,576

(22) Filed: Oct. 24, 2002

(51) Int. Cl. G06F 7/08

(52) U.S. Cl. 235/381

(57) ABSTRACT

An interactive video rental/purchase system enables a potential renter/purchaser to determine the availability of one or more videos from one or more video retail outlets via the internet on a home personal computer. The system provides the user with pricing information, the most geographically convenient location at which one or more videos is currently available, and enables the user to reserve one or more selected videos by placing an immediate hold on the selections. The system also provides the user with access to additional information including trailers of available videos, critics' reviews of the videos, and viewer feedback from other users who have viewed the videos.

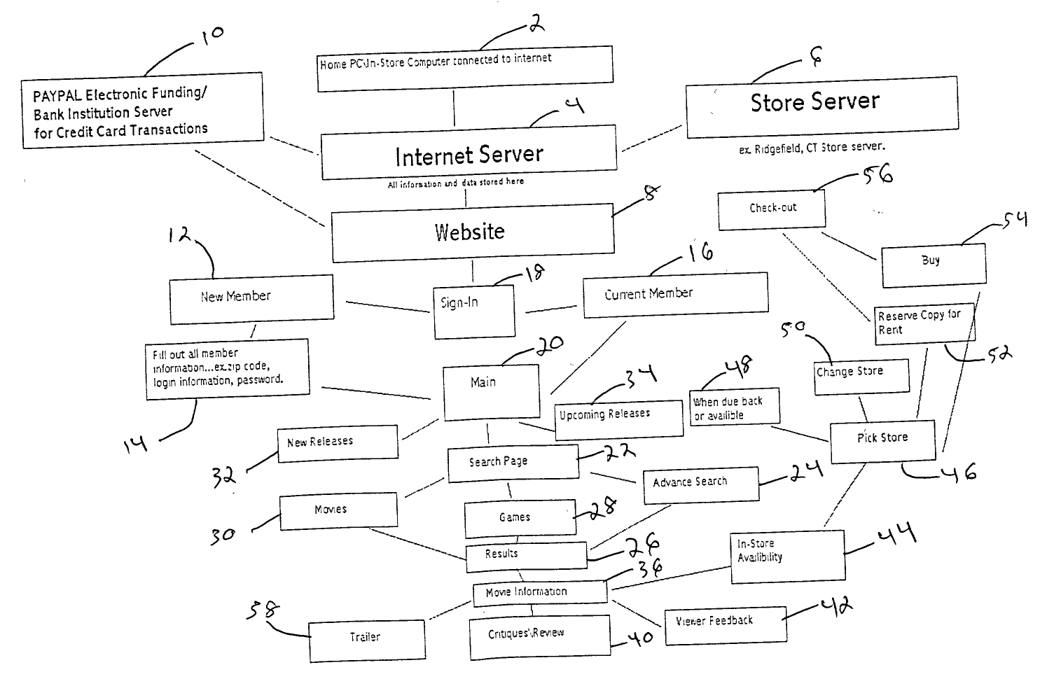

### BACKGROUND OF THE INVENTION

The present invention is directed to systems and methods for renting or purchasing videos, particularly motion pictures, recorded television programming and documentaries, and interactive video games, on video cassettes or DVDs (hereinafter referred to collectively as “videos”).

Over the past several decades, retail outlets for the sale and rental of videos, particularly current and classic motion pictures, recorded television programming, and interactive video games, has proliferated throughout the country. For the most part, renters and purchasers make their selections based upon advertising and word of mouth from acquaintances. The normal procedure for renting a video requires a customer to visit a local video retail outlet to determine the availability of a video to be rented. If the first preference is not available, the customer will usually rent a second or third preferred selection. In the alternative, the customer can call a video retail outlet by telephone to determine the current availability of one or more video selections. If a first preference is not available in a particular video retail outlet, the customer can call other outlets to determine the availability of this video. However, when dealing with video retail outlets by telephone, the possibility exists that a video which was available at the time of the telephone call is no longer available when the customer arrives at the location, or a video that was not available at the time of the telephone call subsequently becomes available unbeknownst to the customer.

The known systems for renting videos are exemplified by the following prior art patents: U.S. Pat. Nos. 5,237,157; 5,095,195; 5,084,768; 5,028,766; 4,414,467; and 4,300,040. These systems generally disclose terminals at selected locations for enabling a potential customer to preview a short segment (i.e., a trailer) of one or more videos to assist the customer in making a final selection of a video to be rented or purchased.

It is the primary object of the present invention to overcome the known disadvantages, some of which have been discussed above, in current video rental procedures. This objective is accomplished by providing a system by which a customer is able to interact, in real time, with a video rental network comprising a plurality of video retail outlets for providing real time current information regarding, among other things, the availability, pricing and content of videos, and enabling the customer to place an immediate hold or reservation on one or more selected videos. Other advantages of the systems and methods in accordance with the present invention will become apparent from the following discussion.

### SUMMARY OF THE INVENTION

Methods and systems for renting or purchasing video cassettes or DVDs (videos) from video retail outlets include an interactive network formed from a plurality of video retail outlets at different geographical locations. The network is accessible by one or more different customers, via the internet, at different geographical locations through a home personal computer (PC). The interactive network enables each of the customers accessing the system to obtain current (real time) information regarding the availability of one or more videos in one or more of the video outlets in the network, the identification of the video outlet having the available video at the most convenient geographical location to the customer, and pricing information for videos in each of the video retail outlets in the network. By providing real time information regarding the availability of videos in each of the video retail outlets in the network, a customer can monitor each video outlet in the network to determine the exact time when a previously unavailable video has become available (e.g., as a result of a return of a video by another customer) in one or more of the video retail outlets within the network.

The methods and systems in accordance with the present invention also provide a user with access to additional information including a trailer (a presentation of a short portion of a video) of each video in stock (whether currently available or unavailable) in each video retail outlet within the network; reviews by movie critics, if available, for each video within the network; background and historical information, if available, for each video in the network; and comments relating to the videos in the network provided by customers who have previously viewed the videos. The interactive system also enables customers, in addition to accessing comments of prior customers, to post their own comments and opinions regarding videos in the network that they have viewed.

The interactive network also enables a customer to place an immediate hold or reservation on a specific video in a specific video outlet, if the video is currently available, by providing credit card or other payment information. In the alternative, the system enables a customer to place a hold or reservation on a specific video, currently unavailable at a specific video retail outlet, and notify the customer by e-mail once the requested video becomes available. If more than a single customer requests a hold on an unavailable video in a specific video retail outlet, the earliest in time reservation will receive the first returned copy of the video to that location, the second earliest in time reservation will receive the second returned video to that location, etc. A customer may also cancel the reservation at any time before the requested video is returned to that location. Moreover, a customer may reserve a specific video at more than a single video retail outlet in the network, and once the requested video is returned to any of the designated video retail outlets, the reservation for the video will automatically be cancelled in all of the other video retail outlets that were designated by the customer.

### BRIEF DESCRIPTION OF THE DRAWINGS

The single drawing figure is a diagram of an interactive video rental and purchase system and method in accordance with the present invention.

### DESCRIPTION OF THE PREFERRED EMBODIMENTS EMBODIMENTS FOR CARRYING OUT THE INVENTION

The single drawing figure is a chart illustrating features of the interactive systems and methods for renting/purchasing videos in accordance with the preferred embodiments of the present invention.

The user interacts with the system from a remote location via a home personal computer (PC) designated generally by reference numeral 2. The PC 2 is coupled to an internet server generally designated by reference numeral 4, and to a website generally designated by reference numeral 8. A store server representing a single retail video outlet location, generally designated by reference numeral 6, is electronically coupled to the internet server 4. The overall system includes a plurality of store servers 6, each representing different video retail outlet locations, electronically coupled to the internet server 4. Known electronic payment means, for example, the PAYPAL payment system, generally designated by reference numeral 10, is coupled to both the internet server 4 and the website 8 to permit a user to electronically pay for the rental or purchase of a video through the interactive system of the present invention.

The system includes means, generally designated by reference numerals 12 and 14, for permitting new members to subscribe to the video rental/purchase system in accordance with the present invention. Both new subscribers and current members, generally designated by reference numeral 16, are provided with means, generally designated by reference numeral 18, to log into the system (preferably by use of an assigned personal identification number (PIN)), thereby accessing the main menu designated by reference numeral 20.

The main menu provides the user with numerous options which include, among others, identifying, locating, previewing, reserving and renting/purchasing one or more selected videos. For example, the user may access a search page designated by reference numeral 22 and/or initiate an advance search designated generally by reference numeral 24. The results of the search are displayed to the user on the screen of his PC 2, as generally designated by reference numeral 26. In addition to locating videos of motion pictures and recorded television programming during the search, it is within the scope of the present invention that the disclosed system also locate and identify interactive video games, generally designated by reference numeral 28.

During the course of the search, the user of the system can access specific videos such as movies as designated generally by reference numeral 30. Additionally, the user can generally search for new releases of movies which are currently available, as generally designated by reference numeral 32, or in the alternative, upcoming movie releases, which are not yet available but will be shortly, as generally designated by reference numeral 34. As noted, the results of the search are displayed on the screen of the user's PC 2, generally designated by reference numeral 26.

Once one or more selected videos have been identified, the user of the system can selectively access additional information relating to the videos, as generally designated by reference numeral 36. The additional information includes the display of a trailer (a preview of a small portion of the video) for each selected video, generally designated by reference numeral 38; critiques and reviews (e.g., newspaper, magazine, television and radio reviews, where available) for each selected video, generally designated by reference numeral 40; and interactive feedback, generally designated by reference numeral 42, posted by subscribers to the system providing their comments and evaluation of videos which they have reviewed. The system also provides means by which any member is able to post his/her comments and critique of one or more videos on the system to be viewed by other members.

The methods and systems in accordance with the present invention also enable each user to determine the in-store availability, generally designated by reference numeral 44, of any video currently carried by any retail outlet location 6 within the system. In this regard, the user can designate a specific retail outlet known to him, as generally designated as reference numeral 46, and the system will provide information relating to the availability of designated videos in that specific retail outlet, including the date and time when the videos are due to be returned to the specific retail outlet if they are currently unavailable, as designated by reference numeral 48. The user can request the system to access a different video retail outlet 6, as generally designated by reference numeral 50, to determine the availability of selected videos in this other video retail outlet. In the alternative, the user can access the system to identify the specific video retail outlets 6 in which one or more selected videos are currently available, without designating a specific video outlet. The system will identify the specific video retail outlets in which the selected videos are currently available, as for example the identity of the video retail outlets geographically closest to the user, and provide the user with directions to these video outlets.

If the selected videos desired by a user are currently available in a designated retail outlet 6, the user may reserve the video by providing the video retail outlet with payment information inputted into the system by the payment means designated by reference numeral 10. The payment can be made by the user to either rent (reference numeral 52) or purchase (reference numeral 54) one or more selected videos. The user thereafter visits the specific video retail outlet 6 at which he/she has rented or purchased the video to checkout (reference numeral 56) the video.

In the event that one or more selected videos is currently not available at one or more video retail outlets 6 selected by the user, the system enables the user to nonetheless reserve the videos pending return of the videos to the designated retail outlet 6. For example, the user can reserve one or more videos at one or more video retail outlets 6 by providing each video outlet with payment information (reference numeral 10). The user may cancel the reservation at one or more of the video retail outlets at any time prior to the return of the video to the video retail outlet at which the reservation has been made. Once a reserved video is returned to one of the designated video retail outlets at which a reservation has been made and remains in effect, this video retail outlet forwards a message to the user by e-mail on his/her PC 2 that the reserved video is currently available. Simultaneously, any reservation for this same video which has been made in any other video retail outlet 6 within the system, is automatically cancelled. In the event that more than one user reserves the same video at the same video retail outlet, the different users are notified of the availability of returned videos in the order corresponding to the time at which the respective reservations were made, the earlier reservation receiving priority over reservations made later in time.

In accordance with the methods and systems of the present invention, an interactive system and network is provided by which a user can identify videos, access several different categories of information relative to the video, identify one or more retail locations in which a selected video is currently available or will be available in the future, reserve or purchase the selected video at a designated retail outlet, and post a critique of the video on the network after it has been viewed by the user. The system and network can be accessed by the user from a remote location, as for example, the user's home or office, through the internet via the user's home personal computer. The system and network in accordance with the present invention provides the user with information enabling the user to make an informed selection with regard to one or more videos to be rented or purchased, and thereafter enables the user to efficiently and immediately reserve one or more selected videos in one or more selected video retail locations.

Other features and advantages of the systems and methods falling within the scope of the present invention will become apparent to those skilled in the art. Accordingly, the discussion of the preferred embodiments of the systems and methods herein is intended to be illustrative only and not restrictive of the scope of the invention, that scope being defined by the folloiwng claims and all equivalents thereto.

Attached hereto as an Appendix is a printout of a program implementing and illustrating the system and methods in accordance with the present invention.

1. A system for renting or purchasing video cassettes, digital video disks (DVDs), or video games over a global communications network (the internet), said system comprising:
means for accessing said network by a user from a first predetermined location;
means for accessing a first video rental/sales outlet at a second predetermined location through said network for determining current availability of one or more designated video cassettes, digital video disks, or video games at said first video rental/sales outlet; and
means for reserving at least one said designated video cassette, digital video disk, or video game at said video rental/sales outlet through said network by said user at said first predetermined location.

2. The system as claimed in claim 1, further including:
means for accessing at least a second video rental/sales outlet at a third predetermined location through said network;
means for determining the current availability of said one or more designated video cassettes, digital video disks, or video games at said second video rental/sales outlet; and
means for reserving at least one said designated video cassette, digital video disk, or video game at said second video rental/sales outlet;
wherein said user can, at his selection, determine the availability of, and reserve, one or more of said designated video cassettes, digital video disks, or video games from either of said first and second video rental/sales locations through said network from said first predetermined location.

3. The system as claimed in claim 1, further including:
means for accessing a plurality of video rental/sales outlets at a plurality of different predetermined locations through said network;
means for determining current availability of one or more of said designated video cassettes, digital video disks, or video games at each of said plurality of video rental/sales outlets; and
means for reserving at least one said designated video cassette, digital video disk, or video game at any of said plurality of video rental/sales outlets;
wherein said user can, at his selection, determine the availability of, and reserve, one or more of said designated video cassettes, digital video disks, or video games from any of said plurality of video rental/sales outlets through said network from said first predetermined location.

4. The system as claimed in claim 3, further including:
means accessible by said user through said network from said first predetermined location for selectively reviewing at said first predetermined location, a trailer of one or more said designated video cassettes, digital video disks, or video games.

5. The system as claimed in claim 3, further including:
means accessible by said user through said network from said first predetermined location for selectively viewing at said first predetermined location, commentaries, reviews, or critiques of one or more of said designated video cassettes, digital video disks, or video games.

6. The system as claimed in claim 3, further including:
means for posting information on said network relating to at least one of said designated video cassettes, digital video disks, or video games by said user from said first predetermined location.

7. The system as claimed in claim 6, further including:
means for accessing by said user at said first predetermined location, information posted on said network by other users of said system.

8. The system as claimed in claim 3, wherein said means for reserving includes means for notifying said user at said first predetermined location through said network when one of said designated video cassettes, digital video disks, or video games becomes available at one of said plurality of said video rental/sales locations, and means for automatically cancelling reservations for said available designated video cassette, digital video disk, or video game at each of said other of said plurality of video rental/sales locations.

9. The system as claimed in claim 3, further including:
means for identifying which of said plurality of video rental/sales locations at which said designated video cassette, digital video disk, or video game is currently available, is geographically closest to said user at said first predetermined location.

10. A system for renting or purchasing video cassettes, digital video disks (DVDs), or video games over a global communications network (the internet), said system comprising:
means for accessing said network by a user from a first predetermined location;
means for accessing a plurality of video rental/sales outlets at a plurality of different predetermined locations through said network for determining current availability of one or more designated video cassettes, digital video disks, or video games at each of said plurality of video rental/sales outlets;
means for reserving at least one said designated video cassette, digital video disk, or video game at one or more of said plurality of video rental/sales outlets through said network by said user at said first predetermined location;
means accessible by said user from said first predetermined location through said network for selectively previewing at said first predetermined location, a trailer of one or more of said designated video cassettes, digital video disks, or video games; and
means accessible by said user from said first predetermined location through said network for selectively viewing at said first predetermined location, commentary, reviews, or critiques of one or more of said designated video cassettes, digital video disks, or video games.

11. A method for renting or purchasing video cassettes, digital video disks (DVDs), or video games over a global communications network (the internet), the steps of said method comprising:
accessing at least a first video rental/sales outlet through said network by a user at a predetermined location;
determining the current availability of one or more designated video cassettes, digital video disks, or video games at said first video rental/sales outlet through said network by said user at said first predetermined location; and
reserving at least one said designated video cassette, digital video disk, or video game at said first video rental/sales outlet through said network by said user at said first predetermined location.

12. The method as claimed in claim 11, further including the step of:
accessing at least a second video rental/sales outlet through said network by said user at said first predetermined location;
determining the current availability of one of said designated video cassettes, digital video disks, or video games at said second video rental/sales outlet; and
reserving at least one said designated video cassette, digital video disk, or video game at said second video rental/sales outlet;
wherein said user can, at his selection, determine the availability of, and reserve, one or more of said designated video cassettes, digital video disks, or video games from either of said first and second video retail/sales locations through said network from said first predetermined location.

13. The method as claimed in claim 1, further including the steps of:
accessing a plurality of video rental/sales outlets at different locations through said network by said user at said first predetermined location;
determining current availability of at least one said designated video cassette, digital video disk, or video game at each of said plurality of video rental/sales outlets; and
reserving at least one said designated video cassette, digital video disk, or video game at one or more of said plurality of video rental/sales outlets;
wherein said user can, at his selection, determine the availability of one or more of said designated video cassettes, digital video disks, or video games at each of said plurality of said video rental/sales outlets through said network from said first predetermined location.

14. The method as claimed in claim 13, further including the steps of:
accessing a trailer of one or more of said designated video cassettes, digital video disks, or video games by said user through said network at said first predermined location to permit said user to selectively preview said trailer at said first predetermined location.

15. The method as claimed in claim 13, further including the steps of:
accessing commentary, reviews, or critiques of at least one of said designated video cassettes, digital video disks, or video games by said user from said first predetermined location through said network for selectively viewing said commentary, review or critique at said first predetermined location.

16. The method as claimed in claim 13, further including the steps of:
posting information relating to one or more of said designated video cassettes, digital video disks, or video games on said network by said user from said first predetermined location.

17. The method as claimed in claim 16, further including the steps of:
accessing by said user at said first predetermined location, information posted on said network by other users of said system.

18. The method as claimed in claim 13, wherein said step of reserving includes the steps of notifying said user at said first predetermined location through said network when one of said designated video cassettes, digital video disks, or video games becomes available at one of said plurality of said video rental/sales locations, and automatically cancelling reservations for said available designated video cassette, digital video disk, or video game at each of said other plurality of video rental/sales locations.

19. The method as claimed in claim 13, further including the steps of:
identifying which of said plurality of video rental/sales locations is geographically closest to said user at said first predetermined location at which said designated video cassette, digital video disk, or video game is currently available.

20. The system as claimed in claim 14, further including the steps of:
means accessible by said user from said first predetermined location through said network for selectively viewing commentaries, reviews, or critiques of one or more of said designated video cassettes, digital video disks, or video games.
